(19) United States
(12) Patent Application Publication
(10) Pub. No.: US 2003/0236696 A1
(43) Pub. Date: Dec. 25, 2003

(54) Method and system for visual comparison and/or evaluation

(75) Inventors: David Fabricant, Hoboken, NJ (US); Srinivasan Krishnan, Union City, NJ (US); Anthony Cece, West Orange, NJ (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/177,793

(22) Filed: Jun. 20, 2002

(51) Int. Cl. G06F 17/60

(52) U.S. Cl. 705/10

(57) ABSTRACT

The invention provides a website based method for comparing product or product concepts or for comparing single product or concept over two or more time intervals. The novelty of the invention is making such forced choice testing over a website made accessible to selected panelists.

### FIELD OF THE INVENTION

The present invention relates to a novel method and system for making a visual comparison and/or evaluation of any product or concept which can be visually represented on a computer website. For example, the system may involve a test for comparing and selecting preference between two or more products or between single products tested at two or more time intervals (a so-called “forced comparison” test) and/or it may involve an evaluation or ranking of a product or concept. The invention further relates to a system wherein said novel method is employed. The novelty revolves about depicting said product(s) and/or concept(s) on a computer and establishing the test (e.g., for soliciting information) on a computer website, wherein the information can be accessed at the convenience of the consumer and recruitment of “panelists” can be asynchronous.

### BACKGROUND OF THE INVENTION

The use of computers and of the internet for conducting various tests is not itself novel. U.S. Pat. No. 6,319,207 B1 to Naidoo, for example, discloses a tool for detecting hearing loss which is conducted over the internet.

The reference fails to disclose a method or system for conducting a visual comparison and/or evaluation (e.g., rating, ranking) of a concept or concepts and/or of product or products.

U.S. Publication No. 2001/0040992 A1 discloses a method of evaluating differences in diagnostic quality between medical images displayed at different rates. These images are displayed in a computer.

The reference is not concerned, however, with a method of conducting a consumer panel or evaluation by posting images or movies on a computer website, and allowing consumers to access to said website at a time convenient to them to conduct visual comparison and/or evaluation.

U.S. Pat. No. 6,261,229 to Gotschim discloses a method for gathering and displaying data. Again, there is no disclosure of posting data (visual images) to a website and allowing panelist to access and evaluate at a place and type of their choosing.

### BRIEF SUMMARY OF INVENTION

More particularly, the present invention relates to a website based method for administering (conducting) a test for visually comparing two or more, or visually evaluating one or more product(s) or product concept(s) (e.g., in a forced comparison between two or more product/concepts or evaluation of a single product or concept over two or more time intervals) wherein said method comprises:

(a) generating computer pictures (e.g., still pictures or as a stream) of the product or product concept; or of the two or more products or product concepts;

(b) posting said pictures or movies on a computer website;

(c) providing access to the website to consumers who can be geographically located at any site desirably chosen by the consumer; and

(d) providing instructions to said consumer(s) to compare and select a choice or choices from among the posted pictures or movies in conforming with a desired test (e.g., paired comparison, ranking order, rating scale, ratio scale, categorized test).

In a second aspect of the invention, the invention relates to a system for conducting said visual comparison or evaluation testing (i.e., selection of preferred choice) using the method described above.

### BRIEF DESCRIPTION OF THE FIGURES

FIG. 1 is a graph of MPEG study depicting response choices/preferences based on various stimuli (i.e., percent of panelists preferring a given choice based on the stimulus). Each bar represents a stimulus. The graph presents 12 unique stimuli that were paired together to create a probe during the testing session. The chart covers 12 sets of tests with 12 stimuli. The first set comprises Male Negative Control (the negative control with a skin treatment formulation) at baseline, 30 minutes and 2 hours (i.e., pictures of Male Negative at a 0 minutes versus 30 minutes or at 0 minutes versus 2 hours or at 30 minutes versus 2 hours etc.); the second comprises Female Negative control at baseline, 30 minutes and 2 hours; the third comprises male skin treated with Christian Dior formulation at 0, 30 and 120 minutes; and the fourth was female skin treated with Christian Dior formulation over same three periods.

FIG. 2 is a comparison in the “Softness” test between 2 clinicals and website (using still, JPEG figures).

FIG. 3 is a comparison in the “Smoothness” test between 2 clinicals and website (using still JPEG figures).

### DETAILED DESCRIPTION OF THE INVENTION

The present invention relates to a novel method for collecting data relating to visual comparison of two or more products or concepts and/or visual evaluation (e.g., ranking, rating) of one or more product and/or concepts.

Such data is often collected to consumer panelists using a variety of tests including, but not limited to, paired comparisons, ranking order, rating scales, ratio scales and categorized scales.

The Paired Comparison method involves making pairs of all possible combinations of a group of different samples. The sample pairs are shown to the observers who in turn select which one of each pair is preferred (based on some defined criteria). The law of comparative judgments is applied to analyze the data. The results may be depicted with a table of data and graphs.

The Ranking Order method involves ranking a variety of samples in order of some defined criteria. For example, if an observer is shown four images, the observer would be asked to rank them number 1 through 4, in order of quality or other defined criteria. Number 1 would correspond to the “best” of the 4 images. Number 4 would correspond to the “worst”. Like the Paired Comparison method, the law of comparative judgments may be applied to analyze the data.

The Categorical Scale method involves viewing each sample alone and not in comparison with others. The observer is asked to place each sample in a category which has been pre-defined by the experimenter. For example, the experimenter may set up the following image categories: (1) lowest imaginable quality, (2) low quality, (3) acceptable quality, (4) high quality, and (5) highest imaginable quality. The observer would be shown one sample at a time and instructed to place that sample in one of these five categories.

The Rating Scale method involves a comparison of a sample with two standards which are at both extremes of a defined scale (e.g., quality scale). The observer is told that the one standard which is associated with the highest quality image is ranked number 10 on a 10 point scale. He is further told that the other standard which is associated with the lowest quality image is ranked 0 on the same scale. Finally, he is shown each of the samples, asked to compare each with the two standards and assign a numerical rating between 0 and 10 to each sample.

The Ratio Scale method is a very similar to the Rating Scale method previously described. The only difference is that only one standard is used for purposes of comparison and assigning a numerical rating.

The above methods themselves and their statistical analysis are fully described in James Bartleson and Franc Grum, “Visual Measurements”, which is Volume 5 in “Optical Radiation Measurements”, Academic, Orlando, 1984; and J. P. Guilford, “Psychometric Methods,”” McGraw-Hill, 2^{nd} Edition, 1954, which publications are incorporated herein by reference in their entirety.

While such compiled data is very important in determining consumer preferences, it is often very difficult to collect all the data points without great exertion of time and effort.

Unexpectedly, applicants have discovered that, if the product(s) and/or concept(s) are generated as computer pictures or movies (e.g., on JPEG, MPEG or other file for visual representation) and posted on a website owned or run by the party desiring to collect the data, it is possible to much more efficiently (i.e., in greater numbers and with much less effort) collect choices from consumer or panelists. Moreover, recruitment can be completely asynchronous, with the data collection at times that are convenient to the consumer. The data can be readily compiled using, for example, a spread sheet program which can instantaneously compile and analyze data as soon as it is inputted. Another benefit is that images may be served up dynamically in random order (generated by computer or coordinator) and that several consumers may participate in the study at the same time, irrespective of geographic location.

By website is meant a collection of pages on the internet that have a common theme, in this particular case, the collection and analysis of consumer preference data.

Pictures may be in any form which can be visually captured (any web enabled image format) and can include, without limitation, gif, pict, bmp etc.

As indicated, the information compiled represents decisions or choices made based on comparison of two or more products or product concepts; or evaluation (ranking, rating according to any of tests noted, for example) of one or more product(s) and/or concept(s)

The “product” or “concept” compared is not limited in any way and may encompass, for example, anything from a comparison of two pieces of clothing washed in different formulations to a comparison of two arms which have been treated with different personal wash formulations. It may in reality encompass any concept or product which can be visually represented to compare or evaluate as noted.

For example, two arms may be washed in separate formulations, pictures taken of the arm, and the effect (e.g., irritation, erythema, etc.) the formulation may have on the skin may be evaluated by a consumer who has logged into the computer and agreed to make a choice, or a consumer may give a rating to the arm according to a pre-conceived scale.

A comparison or evaluation, as noted, may also be between two concepts. Thus, for example, it is possible to create a video “movie” (i.e., on AMPEG file) of a new advertisement campaign and compare to a second movie or to rate a single movie again according to a defined scale.

What is clear is that the invention is directed to the novel way of making the choice (posting visual image to website and granting access to such at a time and place of consumer's choosing) rather than to the underlying product or concept tested.

Similarly, for example, a comparison may be between a single cloth which has been washed 10 times versus 5 times or which has been washed in the same composition for 30 minutes versus 10 minutes (or over any two or more time intervals).

A comparison can be between two products or concepts (generally referred to as a “paired comparison”) or may be between multiple products/concepts wherein the evaluator is asked to choose perhaps one favorite or perhaps 2 or 3 favorites among all choices.

As indicated, the pictures/movies are posted on a website.

Typically, the evaluator or evaluators are given access to the website and provided with a password or means to access the web.

The evaluator may have access to one particular study or the evaluator may be given access to multiple studies which are all accessed by simply clicking at the appropriate place on the screen. The key is that the evaluator may check in at any time at their own leisure and from any geographic site. Essentially, such liberty encourages much wider participation and far less effort than having to bring evaluators/panelists from multiple sites to a single location. In addition, multiple evaluators can access a website seamlessly at the same time from their own computers.

The evaluator is instructed on the screen (or theoretically instructions may have been given in advance) to compare and choose either one or several choices from the group.

The information generated can be immediately tabulated and placed, for example, on an excel spreadsheet where the results can be observed by whoever is administering the tests.

Except in the operating and comparative examples, or where otherwise explicitly indicated, all numbers in this description indicating amounts or ratios of materials or conditions or reaction, physical properties of materials and/or use are to be understood as modified by the word “about”.

Where used in the specification, the term “comprising” is intended to include the presence of stated features, integers, steps, components, but not to preclude the presence or addition of one or more features, integers, steps, components or groups thereof.

The following examples are intended to further illustrate the invention and are not intended to limit the invention in any way.

Unless indicated otherwise, all percentages are intended to be percentages by weight.

### EXPERIMENTAL PROTOCOL

A web site was created by the authors and several studies were designed to compare the website to traditional clinical practices.

An administrator generated a web study which, in this case, displayed two images side by side and asked relevant questions. The panelist was asked to choose which image he or she thinks is more appropriate (e.g., “preferred” for given test) before, optionally, going to the next set.

For the experiment here, 50 people were invited to participate in the web-based study on their computer (using an internet engine such as, for example, Explorer 5.0 or higher).

The online studies were presented over a 3-day period and each panelist was allowed to participate in all three; however, they could only log onto each study once a day. Two studies presented static images (JPEG file) and one displayed moving pictures (MPEG file). The two studies using JPEG images were also run in a clinical setting where pairs of images were presented to panelists under controlled testing conditions.

In the MPEG study consumers were asked to evaluate effect of a negative control (NC; in this case the NC was a commercial skin lotion comprising water, glycerin, etc., although the specific lotion ingredients are irrelevant to the method of the invention), and the effects of skin lotion from Christian Dior, (Capture Essential Yeux; again, the formulation is irrelevant as the invention is directed to evaluation of resulting image(s), no matter how obtained). Each lotion was tested separately on male and female subjects.

Specifically, panelists were asked to evaluate which image had fewer lines and wrinkles. Images were captured using variable illumination angle photography at a baseline point (0 minutes), at 30 minutes and at 2 hours on the crow feet region (crow's feet are fine lines and wrinkles radiating from the eyes) of the right side of the face. Different pairs of images presented to panelists were as follows:

| Male | Female |
|---|---|
| Dior 2 hours vs. NC 2 hours | Dior 2 hours vs. NC 2 hours |
| Dior 30 minutes vs. NC 30 minutes | Dior 30 minutes vs. NC 30 minutes |
| Dior Baseline vs. Dior 30 minutes | Dior Baseline vs. Dior 30 minutes |
| Dior Baseline vs. Dior 2 hours | Dior Baseline vs. Dior 2 hours |
| NC Baseline vs. NC 30 minutes | NC Baseline vs. NC 30 minutes |
| NC Baseline vs. NC 2 hours | NC Baseline vs. NC 2 hours |

As seen above, some pairs were not just within the same set (i.e., NC baseline vs. NC 30 minutes), but were between NC and Dior.

In a second study (JPEG still picture file), panelists were asked which of two images (showing a close-up of skin microstructure) was “softer” and in a third study (also JPEG), they were asked which of two figures was “smoother”. These two studies were also done as clinical studies.

The studies compared the effect of crepey grade (crepey is a medical condition of the skin that attempts to quantify roughness and texture) and transparency levels with people's perception. Crepey grade scale was 0, 4 and 6 (higher being more crepey) and translucency was measured as 1 or 4 (higher number being more translucent).

Examples of scale measurement are noted below.

| | Least Crepey | | Most Crepey |
|---|---|---|---|
| Least Translucent | C0T1 | C4T1 | C6T1 |
| Most Translucent | C0T4 | C4T4 | C6T4 |

The advantages of forced choice presentation are well established and depend on the context of the question. In many applications, forced choice questioning is the most sensitive approach. Relative rankings can be generated from a sequence of forced choice comparisons. For stimuli that vary along a single axis, these relative rankings can be used to establish a scale. For stimuli that vary along multiple dimensions, the forced choice results can be an important initial screen for categorization and sorting. Multiple presentations of a pair of stimuli are used to generate statistics about the reliability of the response. In the analysis below, simple statistical methods were used based on the assumption that judgements are given by an unbiased, noisy, perceptual measurement.

The web page MPEG study noted above presented 12 pairs of images to 40 different panellist. Since panellists were allowed to log on each day there were a total of 48 logins, which resulted in 576 data entries.

The two JPEG studies were done via the web site and in a clinical setting. The “Smooth” study had 15 participates in the clinical study on both days and each panelist viewed 22 pairs during their session. The clinical study generated 330 data entries on each of both days. 40 different people logged onto the web site 49 times over the three-day period and only viewed 16 sets of images, which resulted in 768 data entries.

The “Softness” study had 15 panelists participate in the clinical study on both days and generated 330 data entries on each of both days. 35 different people logged onto the web site 42 times over a three-day period, which resulted in 672 data entries. This is summarized in the table below:

| | Total | | | |
|---|---|---|---|---|
| | Number | Number of | | |
| | of Pairs | Pairs of Images | | Number |
| | of Images | Presented | Number of | of Data |
| Study Name | in Study | to Panelist | Logins | Points |
| Soft Focus | 12 | 12 | 48 | 576 |
| Discrimination | | | | |
| (MPEG) | | | | |
| Softer Attributes | 30 | 22 | 30 | 660 |
| Clinical | | | | |
| Softer Attributes | 30 | 16 | 42 | 672 |
| Web (JPEG) | | | | |
| Smoother | 30 | 22 | 30 | 660 |
| Attributes Clinical | | | | |
| Smoother | 30 | 16 | 49 | 768 |
| Attributes Web | | | | |
| (JPEG) | | | | |

The analysis of these studies generates a percent preference for the individual stimuli in a rank order. When a pair of stimuli is presented, the panelists choose the image based on the question stated. This generates the total number of preferences of one stimuli compared to another. For each stimulus, a sum is generated for the total number of times it is preferred and not preferred. A ratio is generated for the number preferred over the total number of the preferred and not preferred and then presented in rank order on a bar graph. Percent error ratios are calculated at two standard deviations based on the counting statistics:

100*(1.96(√((Preferred Ratio*Not Preferred Ratio)/(Total Number of Presentations)

Differences in monitor settings are a concern for specific types of studies. This tool captures each panelist's screen resolution and color depth. The administrator can look at the overall preference profile results for all the monitor settings and filter out those specific settings that have a unique effect on the study.

### Example 1

### Results of MPEG Study

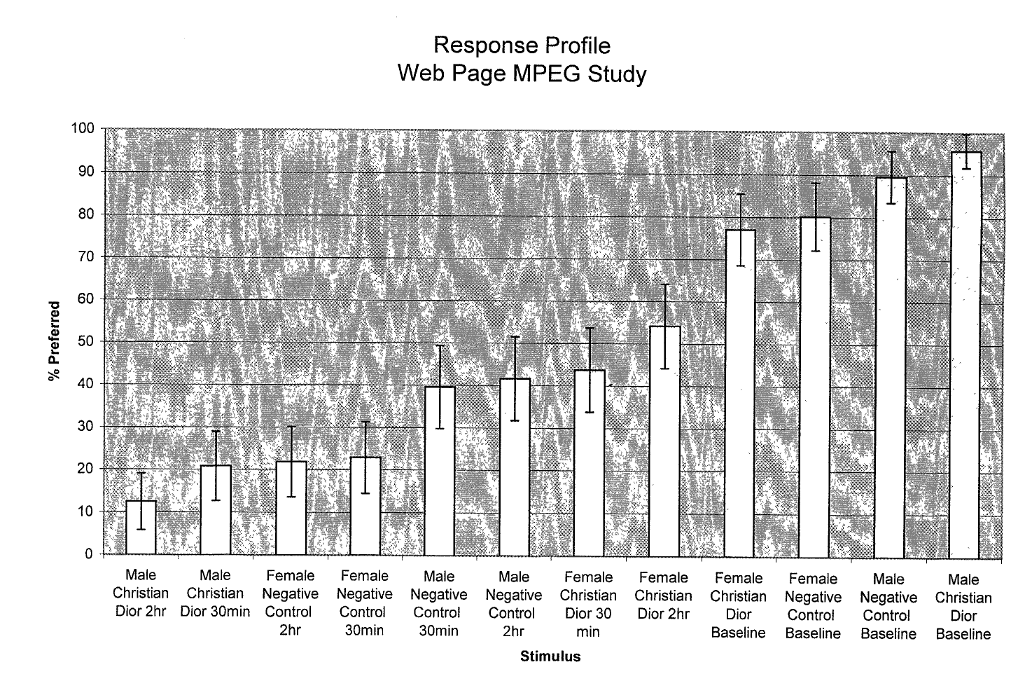

As seen in FIG. 1 the baseline stimuli (no product) are preferred over either of the products. The longer the Dior Christian product is applied to the male skin the less preferred it becomes, however with the female skin there is very little difference between the two time points (30 minutes and 2 hours).

The MPEG study shows results that are consistent with earlier lab findings (see FIG. 1) where the same results are observed.

### Example 2

### Result of “Softness” Study

FIG. 2 shows web-based result versus 2 clinical trials

The evaluation for softness was done three times, twice in a clinical setting with the exact same people participating on two different days and then a separate study done on the web. The results from these three studies show that the panellist consistently concurred with their response and that there was no statistical difference between the studies (FIG. 2) Even though the clinical trial results correlated more directly they had fewer panellists participating in the study and thus their statistical uncertainty was greater.

### Example 3

### Results of “Smoothness” Study

FIG. 3 shows web-based result versus 2 clinical trials.

The same can be said for the smoothness study, which was evaluated in the same manner. The two clinical results directly correlated but were somewhat different from the web page results (Graph 3.) However, since there were so few panellist compared to the web page there was no statistical difference between the results of the two studies.

1. A website based method for visually comparing two or more products or product concepts and/or for evaluating one or more products or concepts, wherein said method comprises:
(a) generating computer pictures or movies of said single product or concept; or of said two or more products or product concepts;
(b) posting said pictures or movies on a computer website;
(c) establishing access to said website to consumers so that the website can be accessed from any geographic location chosen by said consumer; and
(d) providing instructions to said consumers to compare and/or evaluate a choice or choices from said posted pictures or movies.

2. A method according to claim 1, wherein two products or concepts are compared.

3. A method according to claim 1, wherein said pictures are on a JPEG file.

4. A method according to claim 1, wherein said movies are on an MPEG file.

5. A method according to claim 1, wherein instructions are provided on the screen.

6. A method for obtaining data about consumer preference by using method of claim 1.

7. A system for obtaining forced comparison data which comprises using the method of claim 1.
